(19) United States
(12) Patent Application Publication
(10) Pub. No.: US 2016/0031761 A1
(43) Pub. Date: Feb. 4, 2016

(54) Surfactant Composition for Use in Gypsum Wallboard Manufacture

(71) Applicant: Stepan Company, Northfield, IL (US)

(72) Inventors: Lawrence Munie, Avon, IN (US); Jarrod Kaltenbach, Chagrin Falls, OH (US); Mary B. Odisho, Arlington Heights, IL (US); Brian K. Mirous, Evanston, IL (US)

(21) Appl. No.: 14/885,231

(22) Filed: Oct. 16, 2015

Related U.S. Application Data
(63) Continuation of application No. PCT/US2014/343585, filed on Apr. 16, 2014.
(60) Provisional application No. 61/813,044, filed on Apr. 17, 2013.

(51) Int. Cl. C04B 24/16; E04C 2/04; C04B 24/12

(52) U.S. Cl. CPC C04B 24/16; C04B 24/123; E04C 2/04

(57) ABSTRACT

A gypsum composition including calcined gypsum, water, and a foaming agent composition which comprises at least one betaine, either alone or in combination with at least one alkyl sulfate and/or at least one alkyl ether sulfate, is disclosed. The gypsum composition can be used to prepare foamed gypsum wallboard.

### RELATED APPLICATIONS

This application claims priority to PCT Patent Application PCT/US2014/0343585 having an International filing date of Apr. 16, 2014, which claims priority to U.S. Provisional Application No. 61/813,044, filed on Apr. 17, 2013, all of which are incorporated by reference in their entirety.

### FIELD OF THE INVENTION

The present technology relates generally to the manufacture of gypsum wallboard and, more particularly, to an improved surfactant composition for generating foam used in the process of making gypsum wallboard.

### BACKGROUND OF THE INVENTION

In the production of gypsum board, an aqueous core slurry composed predominantly of calcined gypsum is spread between two sheets of paper, cardboard or inorganic fibers, and the resultant core is allowed to set by rehydration of the calcined gypsum (stucco), followed by driving away the excess water by heating the gypsum board in a dryer. In order to decrease the density of the gypsum core, it is a common practice in the industry to incorporate air bubbles in the core. This is normally achieved by the addition of pregenerated foam to the gypsum core slurry mixer, along with other additives, immediately prior to core formation. This foam is normally generated by incorporating air in an aqueous solution of foaming agent in a foam generator.

The dominant trend in the gypsum board industry is trying to achieve lighter weight and stronger gypsum wallboard. In order to achieve the lighter weight, it is necessary to entrap more air. For many years, the gypsum board industry used alkyl ether sulfates as foaming agents in the manufacture of gypsum board. Recently, the industry has moved to utilizing alkyl ether sulfates having specific carbon chain lengths for the alkyl portion and a particular amount of ethylene oxide per mole of the alkyl portion, or a combination of both (U.S. Pat. No. 4,156,615, U.S. Pat. No. 5,085,929, and U.S. Pat. No. 5,116,671). More recently, the industry has considered blending alkyl ether sulfates with alkyl sulfates (U.S. Pat. No. 5,643,510 and U.S. Pat. No. 6,706,128), as well as, using alkyl sulfates as stand alone foamers (U.S. Pat. No. 7,033,431, U.S. Pat. No. 7,220,373, and EP1328485) to achieve a light weight wallboard which can provide an economic advantage through reduced transportation costs for the wallboard, as well as reduced stucco requirements. In addition, lighter weight wallboard can provide an energy savings through a reduced amount of water needed thereby minimizing the energy needed to dry the wallboard.

It would be desirable to provide new foaming agents or blends of foaming agents that can achieve lighter weight wallboard, an improved gypsum core structure, improved gypsum wallboard strength, and reduced water and stucco requirements.

### BRIEF SUMMARY OF THE INVENTION

In a first aspect, the present technology provides a calcined gypsum composition comprising, in combination with calcined gypsum and water, a foaming agent composition comprising at least one betaine. In a further aspect, the present technology provides a calcined gypsum composition comprising, in combination with calcined gypsum and water, a foaming agent composition comprising at least one betaine and at least one surfactant selected from alkyl sulfates and alkyl ether sulfates.

In another aspect, the present technology provides a method of producing a foamed calcined gypsum composition comprising:

mixing a foaming agent composition comprising at least one betaine, optionally in combination with at least one surfactant selected from alkyl sulfates and alkyl ether sulfates, with water and air to generate a foam;

introducing the foam into a calcined gypsum slurry comprising calcined gypsum and water and optionally, a dispersant, a retarder, and an accelerator, to produce a foamed calcined gypsum slurry.

### BRIEF DESCRIPTION OF THE DRAWINGS

FIG. 1 is graphic illustration of the foam stability drainage test results at the two minute mark.

FIG. 2 is a graphic illustration of the foam volume for different blend ratios of two types of betaines using the foam half-life test.

FIG. 3 is a graphic illustration of the foam volume for a blend of a betaine and a branched alkyl sulfate using the foam half-life test.

FIG. 4 is a graphic illustration of the foam volume for a blend of a betaine and an alkyl ether sulfate using the foam half-life test.

FIG. 5 is a graphic illustration of the foam volume for different blend ratios of a betaine and an alkyl sulfate using the foam half-life test.

FIG. 6 is a graphic illustration of the foam half-life in seconds for different blend ratios of two types of betaines using the foam half-life test.

FIG. 7 is a graphic illustration of the foam half-life in seconds for a blend of a betaine and a branched alkyl sulfate using the foam half-life test.

FIG. 8 is a graphic illustration of the foam half-life in seconds for a blend of a betaine and an alkyl ether sulfate using the foam half-life test.

FIG. 9 is a graphic illustration of the foam half-life in seconds for different blend ratios of a betaine and an alkyl sulfate using the foam half-life test.

FIG. 10 is a graphic illustration of the Example 5 slump dispersancy results for a blend of a betaine and a branched alkyl sulfate.

FIG. 11 is a graphic illustration of the Example 5 slump dispersancy results for a blend of a betaine and an alkyl ether sulfate.

FIG. 12 is a graphic illustration of the Example 5 slump dispersancy results for different blend ratios of a betaine and an alkyl sulfate.

FIG. 13 is a graphic illustration of the bubble diameter percent frequency distribution of the core analysis for the slump of a betaine and a branched alkyl sulfate blend, including the core analysis for the individual component slumps.

FIG. 14 is a graphic illustration of the bubble diameter percent frequency distribution of the core analysis for the slump of a betaine and an alkyl sulfate blend, including the core analysis for the individual component slumps.

FIG. 15 is a graphic illustration of the bubble diameter percent frequency distribution of the core analysis for the slump of a betaine and an alkyl ether sulfate blend, including the core analysis for the individual component slumps.

### DETAILED DESCRIPTION OF THE INVENTION

The present technology provides a new surfactant or surfactant blends for use as a foaming agent composition in the manufacture of gypsum board. The surfactant or surfactant blend can be used to generate foam which can be used in conjunction with a variety of gypsum board compositions and manufacturing processes. The surfactant is at least one betaine, which can be used alone, or as a mixture of betaines. The at least one betaine can also be used in combination with at least one additional surfactant to form a surfactant blend. In one embodiment, the surfactant blend comprises at least one betaine and at least one surfactant selected from alkyl sulfates and alkyl ether sulfates. Blends of alkyl sulfate and alkyl ether sulfate in combination with at least one betaine are also contemplated. It is further contemplated that the foaming agent composition can comprise at least one betaine in combination with commercial foaming agents.

The betaine surfactant can be represented by the following formulas:

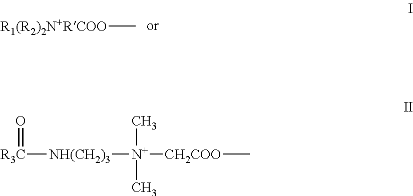

where R₁ is a C₆-C₄₀ alkyl group, each R₂ group is typically C₁-C₃ alkyl, preferably methyl, R′ is a C₁-C₅ alkyl, hydroxyl alkyl, alkoxylated alkyl, or a combination thereof, and R₃ is C₆-C₂₂ alkyl. The betaine can be a pure compound or, alternatively, can be a mixture of different betaines, such as a mixture comprising a betaine of formula I and a betaine of formula II. The betaine can also be a mixture or blend of betaines having different alkyl chain lengths, such as a C₆-C₈ distribution, a C₆-C₁₀ distribution, a C₆-C₁₂ distribution, a C₈-C₁₀ distribution, a C₈-C₁₂ distribution, a C₈-C₁₄ distribution, a C₈-C₁₆ distribution, a C₁₀-C₁₂ distribution, a C₁₀-C₁₄ distribution, a C₁₀-C₁₆ distribution, a C₁₀-C₁₈ distribution, a C₁₂-C₁₄ distribution, a C₁₂-C₁₆ distribution, a C₁₂-C₁₈ distribution, a C₁₄-C₁₆ distribution, a C₁₄-C₁₈ distribution, a C₁₄-C₂₀ distribution, a C₁₄-C₂₂ distribution, a C₁₆-C₁₈ distribution, a C₁₆-C₂₀ distribution, or a C₁₆-C₂₂ distribution. Examples of suitable betaines include cocoamidopropyl betaine, lauramidopropyl betaine, and capryl/capramidopropyl betaine. In one embodiment, the betaine is cocoamidopropyl betaine which is commercially available from Stepan Company under the tradename AMPHOSOL® CG-50 and represented by the following formula:

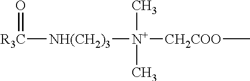

where R₃ is derived from coconut oil. In another embodiment, the betaine is caprylate/caprate amidopropylbetaine which is commercially available from Stepan Company under the tradename AMPHOSOL® 810-B and represented by the following formula:

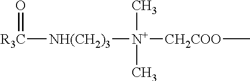

where R₃ is derived from caprylate/caprate methyl esters.

The alkyl sulfate surfactant can be represented by the general formula 1:

R_{X}OSO₃⁻M⁺

where R represents linear or branched chain hydrocarbons having an average of x carbon atoms, and M⁺ represents a cation capable of producing a water soluble surfactant. Typical examples of cations producing a water soluble surfactant include sodium, potassium, magnesium, ammonium, and organic derivatives thereof, such as monoethanolamine, diethanolamine or triethanolamine. In some preferred embodiments, the cation is sodium or ammonium. X is an integer for pure compounds and a non-integer (average value) for mixtures of compounds having various values of x. In general, x will be between 6 and 16. In one embodiment, the alkyl sulfate is a sodium decyl sulfate which is commercially available from Stepan Company under the tradename POLYSTEP® B-25. In another embodiment, the alkyl sulfate is 2-ethyl-hexyl sodium sulfate commercially available from Stepan Company under the tradename STEPANOL® EHS. The alkyl sulfate can also be a blend of alkyl sulfates having different alkyl chain lengths. Typically, the alkyl sulfates are prepared by sulfating the corresponding alcohols.

The alkyl ether sulfate surfactant can be represented by the following formula:

R_{X}(OCH₂CH₂)_{y}OSO₃⁻M⁺

where R represents linear or branched chain hydrocarbons having an average of x carbon atoms, y represents the average number of moles of ethylene oxide per mole of R, and M⁺ represents a cation capable of producing a water soluble surfactant. Typical examples of cations producing a water soluble surfactant include sodium, potassium, magnesium, ammonium, and organic derivatives thereof, such as monoethanolamine, diethanolamine or triethanolamine. In some preferred embodiments, the cation is sodium or ammonium. Both x and y are integers for pure compounds and non-integers (average values) for mixtures of compounds having various values of x and y. In general x will be between 6 and 16, and y will be between 0.01 and 12.

The amount of betaine as a single foaming agent can be between 0.01% and 100% by weight. When the betaine is used in a blend with alkyl sulfate and/or alkyl ether sulfate, the amounts of the alkyl sulfate and/or alkyl ether sulfate surfactant and betaine surfactant in the foaming agent composition can vary. It is contemplated that the amount of betaine in the blend can be from 0.01% by weight to 99.99% by weight of the total foaming agent actives, while the amount of alkyl sulfate and/or alkyl ether sulfate can be from 99.9% by weight to 0.01% by weight of the total foaming agent actives. In some embodiments, the amount of alkyl sulfate and/or alkyl ether sulfate can be from about 10% to about 90% by weight of the total foaming agent actives while the amount of the betaine can be from about 10% to about 90% by weight of the total foaming agent actives. For example, the alkyl sulfate and/or alkyl ether sulfate can comprise about 90%, alternatively about 80%, alternatively about 70%, alternatively about 60%, alternatively about 50%, alternatively about 40%, alternatively about 30%, alternatively about 20%, alternatively about 10% by weight of the foaming agent actives, and the betaine can comprise about 10%, alternatively about 20%, alternatively about 30%, alternatively about 40%, alternatively about 50%, alternatively about 60%, alternatively about 70%, alternatively about 80%, alternatively about 90% by weight of the foaming agent actives. In one embodiment, the foaming agent composition comprises about 20% by weight 2-ethyl-hexyl sulfate and about 80% by weight cocoamidopropyl betaine. The foaming agent composition also includes water, resulting in a foaming composition with an active weight of up to about 50%, alternatively about 30% to about 40% by weight.

In the manufacture of gypsum wallboard, the typical practice is to generate the foam used in the process separately and then add the foam to the calcined gypsum slurry to form the desired core structure. Further details regarding the process steps and systems for manufacturing the gypsum core and gypsum wallboard can be found in U.S. Published Application No. US2008/0223258A1, which is hereby incorporated by reference. The foam used in the process is generated by combining water and the foaming agent composition, then passing the water and foaming agent mixture through a dual pump system where air is added to generate the desired foam density. The concentration of active foaming agent in the foam water can vary widely, but the concentration is typically between about 0.25 to about 0.5% actives. The desired foam density also will vary widely depending on the processing system and the wallboard product being manufactured, and can range from about 4 to about 12 pounds per cubic foot. The foam is then added to the calcined gypsum slurry where, based upon the fluidity and viscosity of the slurry, growth of the bubbles to the desired size happens prior to setting of the slurry.

In an alternative embodiment, each foaming agent is separately introduced into and mixed in the foam generator before adding the foam to the calcined gypsum slurry. The blending of the different foaming agents will affect the bubble structure in the gypsum core. Adjusting the amount of each foaming agent added to the foam generator allows for exact control of the core bubble structure. This can be achieved by generating the foaming agents independently in two or more foaming systems and adding the independent foam streams to the mixer. This allows for varying ratios of 0 to 100% of each separate foaming agent, and allows each producer to optimize the core bubble structure to their needs. Further details regarding the use of two foaming systems can be found in U.S. Pat. No. 5,643,510.

Typical gypsum slurries comprise water and calcined gypsum (anhydrous calcium sulfate or calcium sulfate hemihydrate, also called stucco) which are mixed together to form the calcined gypsum slurry. Additives specific to the particular gypsum board may also be introduced into the slurry. Such additives can include set retarders or accelerators, water-reducing agents, moisture-reducing agents, and fire-resistant agents. Additives are included to impart specific desirable properties to the calcined gypsum slurry and/or the final gypsum board, and may be added prior to or during mixing of the calcined gypsum slurry. Although the typical practice is to pregenerate the foam and mix it with the calcined gypsum slurry, it is also contemplated that the components of the foam (foaming agent composition, water and air) may be independently added to the calcined gypsum slurry.

The primary purpose for using a foaming agent in gypsum board manufacturing is to achieve a lighter weight board. However, the foaming agent composition comprising at least one betaine, or the blend of at least one betaine with alkyl sulfate and/or alkyl ether sulfate, provides several additional benefits. For example, without being bound by theory, it is believed that the betaine component provides enhanced foaming and fluidity, while the alkyl sulfate component destabilizes the bubble structure allowing for coalescence of the smaller bubbles to form larger bubbles.

The betaine surfactant, or the combination of the alkyl sulfate and/or alkyl ether sulfate component with the betaine component, thereby results in a desirable bubble structure that delivers a desired core structure. In addition, the foaming agent composition of the present technology provides an apparent increase in fluidity of the slurry and strength of the final gypsum wallboard. Increased fluidity is advantageous in that it could allow for reduced water or dispersant requirements.

### EXAMPLES

The following examples describe some of the preferred embodiments of the present technology without limiting the technology thereto.

Table A provides the trade names and chemical descriptions for the surfactants used in the examples below. The surfactants are available from Stepan Company, Northfield, Ill.

TABLE A

| | Product Name | Chemical Description |
|---|---|---|
| Commer- | CEDEPAL ® FA-403 | Ammonium Ether Sulfate |
| cial | POLYSTEP ® B-25 | Sodium Decyl Sulfate |
| AS/AES | CEDEPAL ® GFA-02 | Alkyl Ether Sulfate Blend |
| | STEPANOL ® EHS | Sodium 2-Ethyl Hexyl Sulfate |
| Betaine | AMPHOSOL ® 810-B | Capryl/Capramidopropyl Betaine |
| | AMPHOSOL ® CG-50 | Cocamidopropyl Betaine |
| | PETROSTEP ® MME-50 | Modified Betaine Blend |
| | PETROSTEP ® B1235 | Alkyl dimethyl betaine based on |
| | | C12-14 tertiary amine |
| | PETROSTEP ® LME-50 | Capryl/Capramidopropyl Betaine |

### Example 1

### Foam Drainage Stability Test

Laboratory scale experiments were carried out to compare the relative foam stability of foams produced using betaine foaming agents, either alone or in combination with other foaming agents, compared to commercial foaming agents. The different foaming agents used for the tests in this example contained, as active ingredients, (1) AMPHOSOL® 810-B, (2) AMPHOSOL® CG-50, (3) PETROSTEP® LME-50, (4) PETROSTEP® B1235, (5) PETROSTEP® MME-50, all of which are betaines, (6) CEDEPAL® FA-403, (7) POLYSTEP® B-25, (8) CEDEPAL® GFA-02, all of which are commercially available alkyl sulfate or alkyl ether sulfate foaming agents, and (9) a blend of AMPHOSOL® 810-B and STEPANOL® EHS, (10) a blend of AMPHOSOL® 810-B and CEDEPAL® FA-403, and (11) a blend of AMPHOSOL® 810-B and POYLSTEP® B-25. All blends are in a 80:20 active ratio of the betaine to the alkyl sulfate or alkyl ether sulfate. The test samples are prepared by combining 100 mL of room temperature tap water and 0.40% active foaming agent and blending in a blender for 10 seconds at 1600 rpm to generate foam. Then 100 mL of the foam are poured into a graduated cylinder and the amount of water draining is recorded every 15 seconds for 4 minutes. Less water draining from the foam is an indication of better foam drainage stability, especially during the first 2.0 minutes of the test period. Results are shown below in Table 1.

TABLE 1
Foam Stability Drainage Test

| Group | Material | Liquid Volume (mL) | | | | | | | | | | | | | | | | |
|---|---|---|---|---|---|---|---|---|---|---|---|---|---|---|---|---|---|---|
| Com- | CEDEPAL ® | 0.0 | 0.0 | 0.0 | 0.5 | 0.5 | 1.5 | 2.0 | 2.0 | 2.5 | 3.0 | 3.5 | 4.0 | 5.0 | 5.5 | 6.0 | 7.0 | 7.5 |
| mercial | FA-403 | | | | | | | | | | | | | | | | | |
| AS/AES | POLYSTEP ® | 0.0 | 0.0 | 0.5 | 0.5 | 1.0 | 1.5 | 1.5 | 2.0 | 2.5 | 3.0 | 3.5 | 4.0 | 4.5 | 5.0 | 6.0 | 6.5 | 7.0 |
| | B-25 | | | | | | | | | | | | | | | | | |
| | CEDEPAL ® | 0.0 | 0.0 | 0.0 | 0.0 | 0.0 | 0.0 | 0.0 | 0.5 | 0.5 | 1.0 | 1.5 | 2.0 | 3.5 | 4.5 | 5.0 | 5.0 | 6.0 |
| | GFA-02 | | | | | | | | | | | | | | | | | |
| | STEPANOL ® | | | | | | | | | | | | | | | | | |
| | EHS | | | | | | | | | | | | | | | | | |
| Betaine | AMPHOSOL ® | 0.0 | 0.0 | 0.0 | 0.0 | 0.5 | 1.0 | 1.5 | 2.5 | 3.0 | 4.0 | 4.5 | 5.0 | 6.0 | 7.0 | 7.5 | 8.5 | 9.0 |
| | 810-B | | | | | | | | | | | | | | | | | |
| | AMPHOSOL ® | 0.0 | 0.0 | 0.0 | 0.0 | 0.0 | 0.5 | 1.0 | 1.5 | 1.5 | 2.0 | 2.5 | 3.5 | 4.0 | 4.5 | 5.0 | 5.5 | 6.0 |
| | CG-50 | | | | | | | | | | | | | | | | | |
| | PETROSTEP ® | 0.0 | 0.0 | 0.0 | 0.0 | 0.0 | 0.0 | 0.0 | 1.0 | 1.5 | 2.5 | 3.5 | 4.5 | 5.0 | 5.5 | 6.0 | 7.5 | 8.0 |
| | LME-50 | | | | | | | | | | | | | | | | | |
| | PETROSTEP ® | 0.0 | 0.0 | 0.0 | 0.0 | 0.0 | 0.0 | 0.5 | 1.0 | 2.5 | 3.5 | 5.0 | 5.0 | 6.0 | 6.5 | 7.5 | 8.5 | 9.0 |
| | B1235 | | | | | | | | | | | | | | | | | |
| | PETROSTEP ® | 0.0 | 0.0 | 0.0 | 0.0 | 0.5 | 0.5 | 1.0 | 1.5 | 2.5 | 3.0 | 3.5 | 4.5 | 5.0 | 5.5 | 6.5 | 7.0 | 8.0 |
| | MME-50 | | | | | | | | | | | | | | | | | |
| Betaine/ | AMPHOSOL ® | 0.0 | 0.0 | 0.0 | 0.0 | 0.0 | 0.0 | 0.0 | 0.5 | 2.0 | 2.0 | 2.5 | 3.0 | 3.5 | 4.0 | 5.0 | 5.0 | 6.0 |
| Com- | 810-B/ | | | | | | | | | | | | | | | | | |
| mercial | STEPANOL ® | | | | | | | | | | | | | | | | | |
| Blends | EHS | | | | | | | | | | | | | | | | | |
| | AMPHOSOL ® | 0.0 | 0.0 | 0.0 | 0.0 | 0.0 | 0.0 | 0.0 | 1.0 | 2.0 | 2.5 | 3.0 | 3.0 | 3.5 | 4.0 | 5.0 | 5.0 | 6.0 |
| | 810-B/ | | | | | | | | | | | | | | | | | |
| | CEDEPAL ® | | | | | | | | | | | | | | | | | |
| | FA-403 | | | | | | | | | | | | | | | | | |
| | AMPHOSOL ® | 0.0 | 0.0 | 0.0 | 0.0 | 0.0 | 0.0 | 0.0 | 0.5 | 1.0 | 1.0 | 2.0 | 2.5 | 3.5 | 3.5 | 4.0 | 4.5 | 5.0 |
| | 810-B/ | | | | | | | | | | | | | | | | | |
| | POLYSTEP ® | | | | | | | | | | | | | | | | | |
| | B-25 | | | | | | | | | | | | | | | | | |
| | DRAINAGE | 0.00 | 0.25 | 0.50 | 0.75 | 1.00 | 1.25 | 1.50 | 1.75 | 2.00 | 2.25 | 2.50 | 2.75 | 3.00 | 3.25 | 3.50 | 3.75 | 4.00 |
| | TIME (MIN) | | | | | | | | | | | | | | | | | |

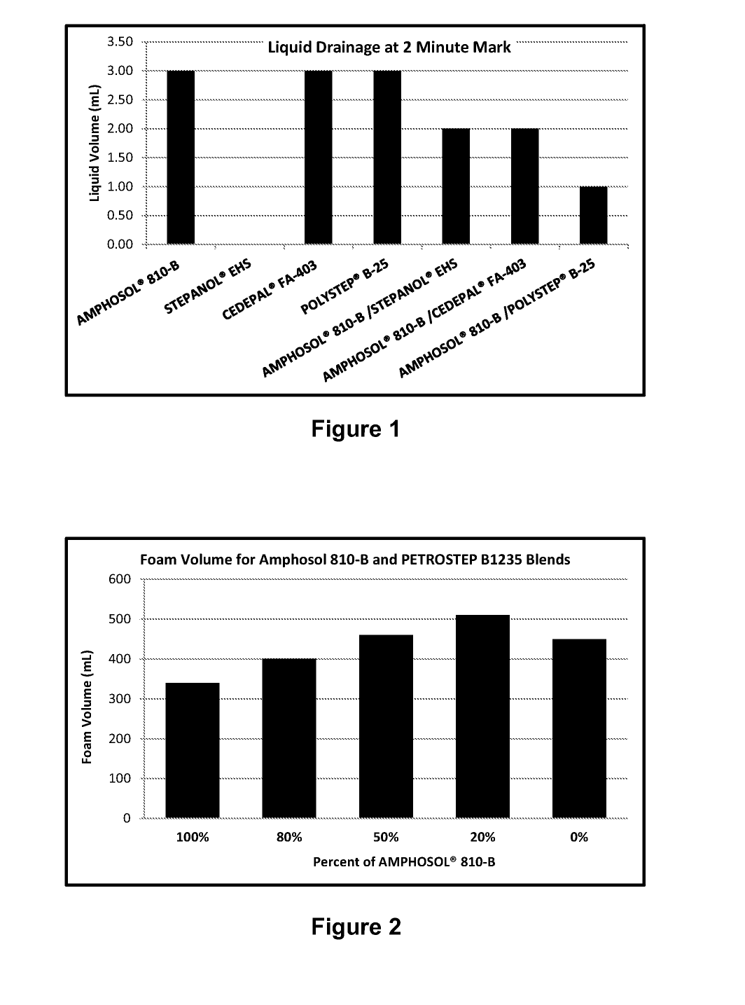

From the results in Table 1, it can be seen that, at time 2.0 minutes, the foam samples containing betaine foaming agents demonstrated equal or better foaming drainage stability than the alkyl ether sulfate (CEDEPAL® FA-403) and alkyl sulfate/alkyl ether sulfate commercial foaming agents. The results in Table 1 also show that, at time 2.0 minutes, the foam samples containing blends of betaine with alkyl sulfate or alkyl ether sulfate had lower amounts of water drainage than the foam samples containing the same betaine or alkyl sulfate or alkyl ether sulfate foaming agent alone. This result is surprising because one would expect that a blend of the foaming agents would have an amount of water drainage that would be between (for example, an average) of the amounts obtained for each individual component of the blend. Instead, mixing a betaine surfactant with an alkyl sulfate or alkyl ether sulfate provides reduced water drainage compared to either surfactant alone, indicating improved foam drainage stability for surfactant blend. This result is also graphically illustrated in FIG. 1.

### Example 2

### Foam Half-Life Test

Test samples using the same betaine and commercial foaming agents used in Example 1 are prepared as solutions of 0.40% active foaming agent in 100 mL of room temperature water containing 342 ppm hardness and blending in a blender for 30 seconds at 2700 rpm to generate foam. The foam is poured into a graduated cylinder and the initial height of the foam is recorded. Using a stop watch, the amount of time for 50 mL of water to drain out of the foam is recorded. This is the half-life of the foam. The height of the foam at the half-life is also recorded. The results are shown in Table 2.

TABLE 2
Half-Life Test Active Foaming Agent Concentration
0.40% in 342 ppm Hard Water

| | Initial | Foam Vol. | Foam ½ | |
|---|---|---|---|---|
| | Foam | (mL) at ½ | life | % added |
| Product Identity | Vol. (mL) | Life | (sec.) | to cyl. |
| AMPHOSOL ® CG-50/ | 640 | 640 | 297 | 94.46 |
| AMPHOSOL ® 810-B | | | | |
| Blend | | | | |
| AMPHOSOL ® CG-50 | 440 | 440 | 312 | 95.65 |
| AMPHOSOL ® 810-B | 610 | 605 | 245 | 94.26 |
| AMPHOSOL ® 810-B/ | 660 | 660 | 300 | 94.22 |
| STEPANOL ® EHS | | | | |
| Blend | | | | |
| CEDEPAL ® FA-403 | 680 | 670 | 295 | 98.52 |
| CEDEPAL ® FA-403/ | 700 | 690 | 333 | 96.58 |
| POLYSTEP ® B-25 | | | | |
| Blend | | | | |

From the results in Table 2, it can be seen that the foam half-life (in seconds) of the betaine foaming agents is comparable to the foam half-life of the commercial foaming agents. Moreover, although the foam volume of the betaine foaming agent test samples was less than the foam volume of the commercial foaming agent samples, the foam volume of the betaine test samples at the foam half-life was remarkably the same or nearly the same as the initial foam volume, indicating good foam stability.

### Example 3

### Slump Test/Stiffening Time

Laboratory scale experiments were carried out to compare the relative fluidity and stiffening times of calcined gypsum slurries resulting from the addition of betaine foaming agents compared to commercial foaming agents. The different foaming agents used for the tests contained, as active ingredients, (1) cocamido propyl betaine, (2) a blend of capryl/capramido propyl betaine and 2-ethyl hexyl sulfate, (3) an alkyl ether sulfate, and (4) a commercially available alkyl sulfate/alkyl ether sulfate surfactant blend. The test samples are prepared by mixing 330 g of calcined gypsum, 2.5 g of starch, 0.50 g boric acid, 1.445 g dispersant, 2.9 g accelerator and 205 g water in a high speed blender for 5 seconds. Foam generated from mixing, in a blender, 0.38% of active foaming agent and 125 g water, is added to the calcined gypsum slurry and mixed for an additional 5 seconds similar to the protocol outlined in US2008/0223258A1.

For the slump test, a 4-inch long, 2-inch internal diameter cylinder is filled with the test slurry and the cylinder is raised to allow the slurry to spread out onto a glass plate surface. The spread distance of the slurry on the glass plate is then measured. A bigger spread distance is an indication of better fluidity of the slurry. For the stiffening test, the slurry is poured onto a glass plate surface to make a cigar-shaped patty. At 5-second intervals, a knife is passed through the patty to make a cut. The cut is closed by the lateral motion of the slurry as long as the slurry stays in a fluid state. The time at which the cut no longer closes is deemed the stiffening time. The results of the slump test and stiffening time are shown in Table 3.

TABLE 3

| | Product Identity | | | |
|---|---|---|---|---|
| | | CEDEPAL ® FA-403/ | | AMPHOSOL ® 810-B/ |
| | | POLYSTEP ® B-25 | AMPHOSOL ® | STEPANOL ® EHS |
| | CEDEPAL ® FA-403 | Blend | CG-50 | Blend |
| Slump (inches) | 8.63 | 8.63 | 9.38 | 9.75 |
| Stiffening Time | 160 | 160 | 160 | 180 |
| (seconds) | | | | |

From the results in Table 3, it can be seen that the test slurries containing the betaine foaming agents have better spread distance than the commercial foaming agents, indicating better fluidity of the slurry. Increased fluidity may allow a decrease in the water added to the calcined gypsum slurry during wallboard manufacture, resulting in less drying time and consequent energy savings. In addition, the test slurries containing the betaine foaming agents have a stiffening time that is the same as those obtained from the slurries containing the commercial foaming agents.

### Example 4

### Foam Half-Life Test

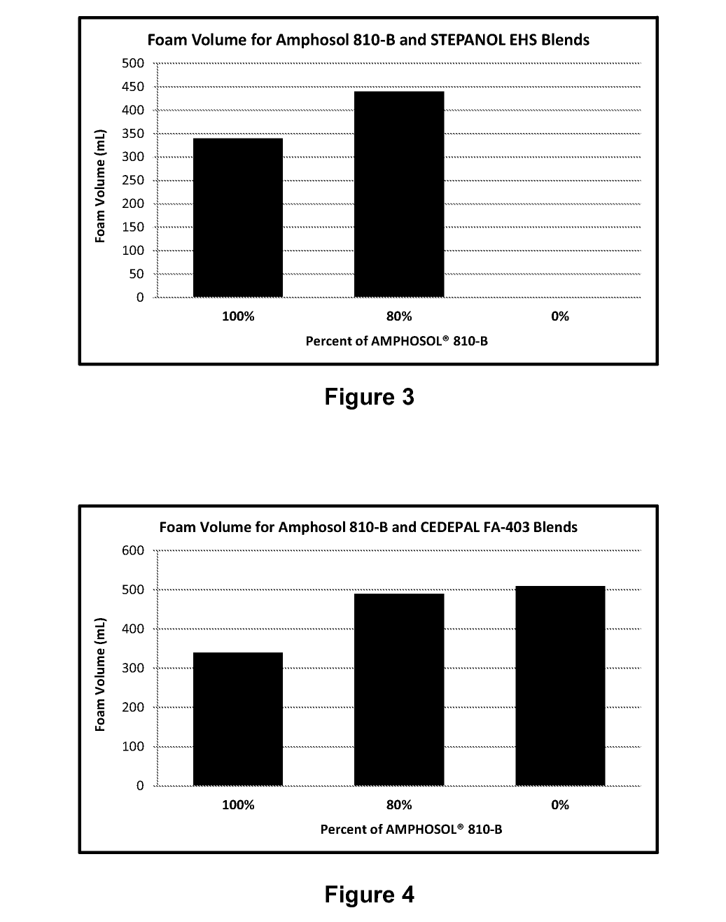

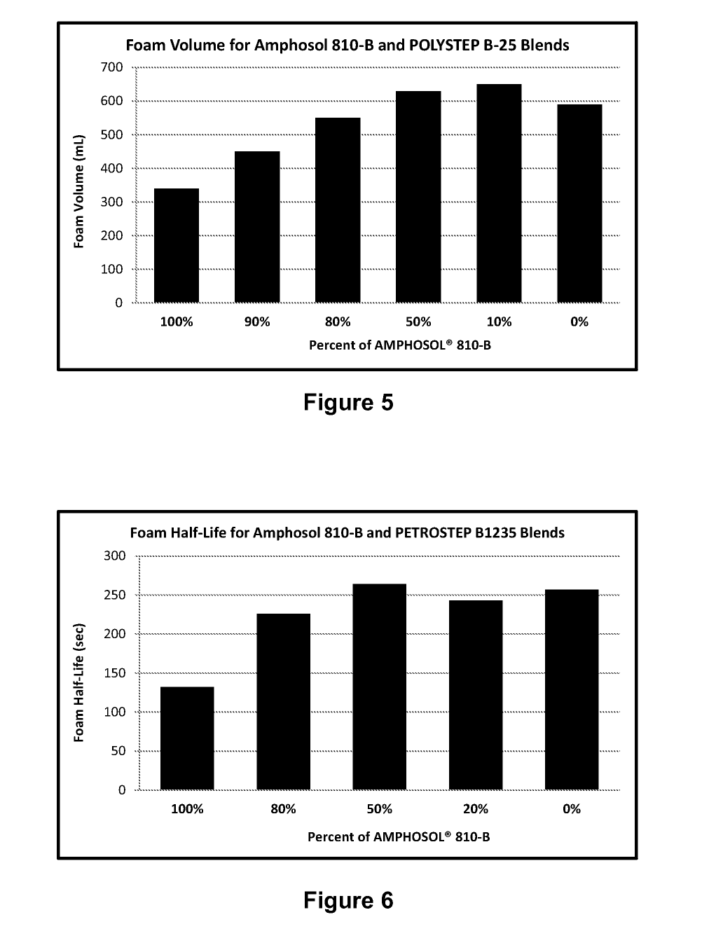

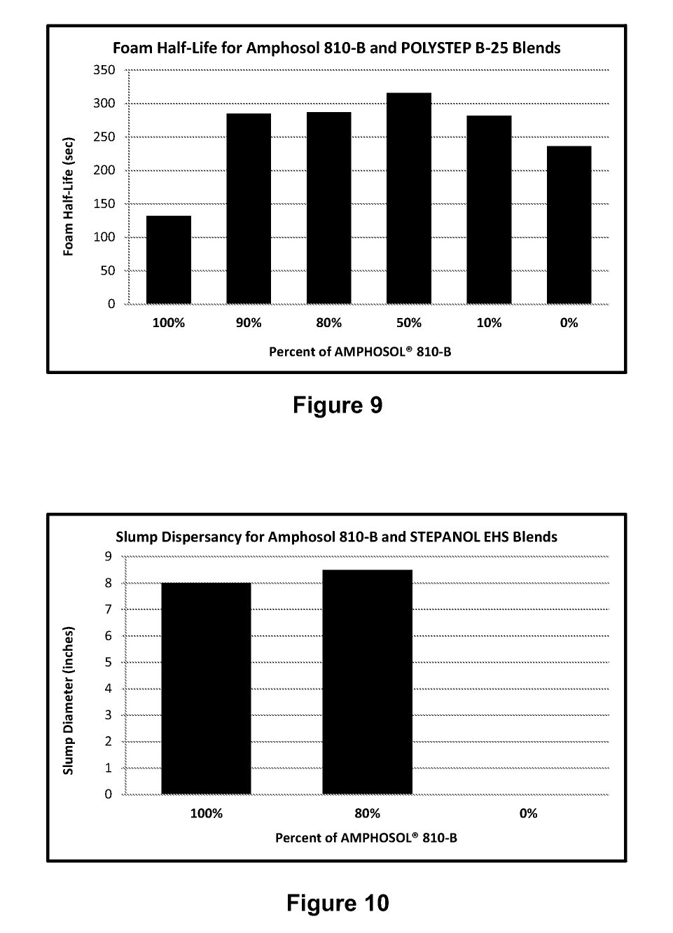

Test samples using the same betaines, commercial foaming agents, and blends of betaine/commercial foaming agents used in Example 1 were prepared as 100 mL of room temperature tap water containing 0.12% actives foaming agent and blending in a blender for 30 seconds at 2700 rpm to generate foam. The foam is poured into a graduated cylinder and the initial height of the foam is recorded. Using a stop watch, the amount of time for 50 mL of water to drain out of the foam is recorded. This is the half-life of the foam. The height of the foam at the half-life is also recorded. The results are shown in Table 4. The foam volume at the half-life for the test samples is graphically shown in FIGS. 2-5. The half-life of the foam in seconds for the test samples is graphically shown in FIGS. 6-9.

TABLE 4
Half-Life Test Active Foaming Agent Concentration 0.12% in Room Temp. Water

| | | | | Foam | | |
|---|---|---|---|---|---|---|
| | | | Initial | Vol. | Foam | |
| | | | Foam | at ½ | ½ | |
| | | Ratio | Vol. | Life | Life | % |
| Group | Product Identity | (%) | (mL) | (mL) | (sec.) | added |
| Commercial | CEDEPAL ® FA-403 | 100 | 515 | 510 | 223 | 95.52 |
| AS/AES | POLYSTEP ® B-25 | 100 | 590 | 590 | 236 | 94.87 |
| | CEDEPAL ® GFA-02 | 100 | 600 | 620 | 228 | 93.88 |
| | STEPANOL ® EHS | 100 | | | | |
| Betaine | AMPHOSOL ® 810-B | 100 | 350 | 340 | 132 | 96.13 |
| | AMPHOSOL ® CG-50 | 100 | 340 | 330 | 132 | 96.00 |
| | PETROSTEP ® LME-50 | 100 | 530 | 520 | 140 | 96.18 |
| | PETROSTEP ® B1235 | 100 | 460 | 450 | 257 | 96.59 |
| | AMPHOSOL ® 810-B/PETROSTEP ® B1235 | 20:80 | 520 | 510 | 243 | 96.26 |
| | AMPHOSOL ® 810-B/PETROSTEP ® B1235 | 50:50 | 460 | 460 | 264 | 95.49 |
| | AMPHOSOL ® 810-B/PETROSTEP ® B1235 | 80:20 | 410 | 400 | 226 | 95.71 |
| | PETROSTEP ® MME-50 | 100 | 390 | 390 | 210 | 97.01 |
| Betaine/ | AMPHOSOL ® 810-B/STEPANOL ® EHS | 80:20 | 445 | 440 | 200 | 95.34 |
| Commercial | PETROSTEP ® LME-50/STEPANOL ® EHS | 80:20 | 630 | 630 | 190 | 93.49 |
| Blends | AMPHOSOL ® 810-B/CEDEPAL ® FA-403 | 80:20 | 480 | 490 | 253 | 96.04 |
| | AMPHOSOL ® 810-B/POLYSTEP ® B-25 | 10:90 | 650 | 650 | 282 | 94.54 |
| | AMPHOSOL ® 810-B/POLYSTEP ® B-25 | 50:50 | 630 | 630 | 316 | 94.85 |
| | AMPHOSOL ® 810-B/POLYSTEP ® B-25 | 80:20 | 550 | 550 | 287 | 95.73 |
| | AMPHOSOL ® 810-B/POLYSTEP ® B-25 | 90:10 | 450 | 450 | 285 | 95.04 |

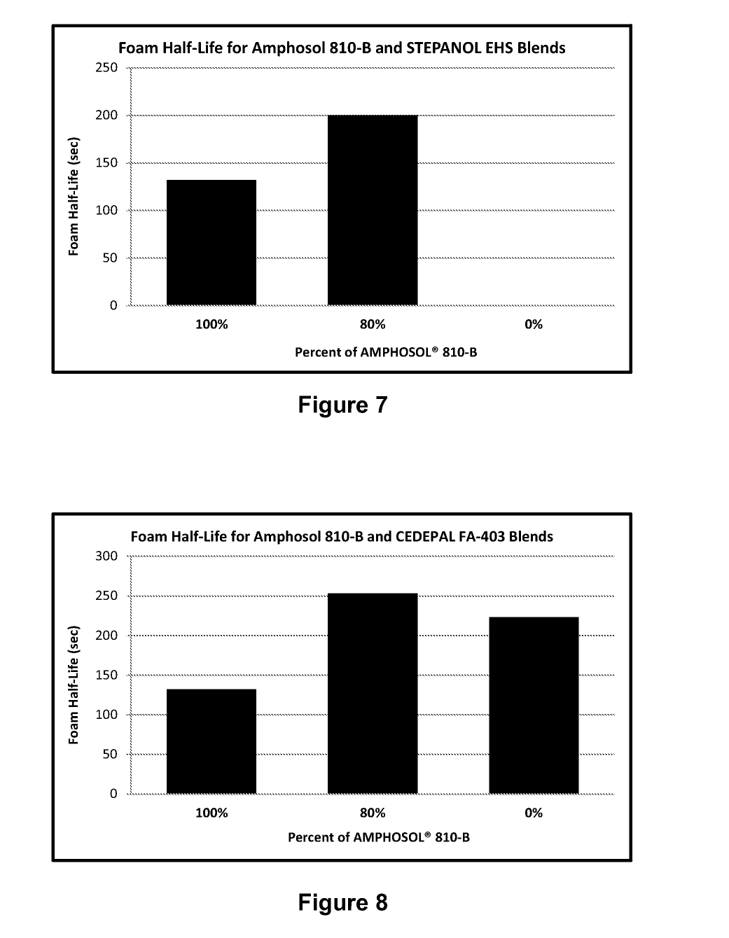

The results in Table 4 show that at least some betaine foaming agents or blends containing betaine foaming agents can provide foam volumes comparable to commercial foaming agents. In addition, the foam volume of the betaine-containing test samples at the foam half-life was the same or nearly the same as the initial foam volume, indicating good foam stability. Surprisingly, the foam half-life (in seconds) of samples containing blends of betaine with alkyl sulfate or alkyl ether sulfate is greater than that of the samples containing either foaming agent alone. This is illustrated in FIGS. 7-9. This further demonstrates the enhanced foam stability that can be achieved by a mixture of a betaine with an alkyl sulfate or alkyl ether sulfate foaming agent.

### Example 5

### Slurry Slump/Initial Set Test

Laboratory scale experiments were carried out to compare the relative fluidity of calcined gypsum slurries containing betaine foaming agents, either alone or combined with commercial foaming agents, to slurries containing commercial foaming agents. The test samples used the same betaines, commercial foaming agents, and blend of betaine/commercial foaming agents used in Example 1. The test samples were prepared by mixing dry additives: 98.87 parts by weight (p/W) of calcined gypsum, 0.28 p/W of ball mill accelerator, 0.71 p/W of starch and 0.14 p/W of boric acid. Separately test samples were prepared by mixing wet additives: 0.58 p/W of dispersant, 0.01 p/W of retarder and 99.41 p/W of water. A 0.12% active foaming agent in water solution (135 g) was blended in a blender for 60 seconds at 2700 rpm to generate foam. Using a syringe, 370 mL of foam is added into a bowl containing the dry ingredients, followed by addition of wet additives, and using the whisk attachment, the slurry matrix is mixed on high in a Hobart mixer.

For the slump test, a 4-inch long, 2 inch internal diameter cylinder is filled with the test slurry and the cylinder is raised to allow the slurry to spread out onto a glass plate surface. The spread distance of the slurry on the glass plate is then measured. A bigger spread distance is an indication of better fluidity of the slurry. For the initial set test, a quarter-pound Gilmore needle is placed on the slump at 5-second intervals to make an indentation. The indentation is made by the quarter pound weight needle on the slurry as long as the slurry remains in a fluid state. The time at which the needle no longer makes an indentation is deemed the initial set time. The results of the slump and initial set test are shown in Table 5.

TABLE 5
Slurry Slump Test

| | | | Slump | Initial Set |
|---|---|---|---|---|
| Group | Product Identity | Ratio % | Diameter (in) | (sec) |
| Commercial | CEDEPAL ® FA-403 | 100 | 7⅞ | 198 |
| AS/AES | POLYSTEP ® B-25 | 100 | 7⅜ | 195 |
| | CEDEPAL ® GFA-02 | 100 | 6¾ | 209 |
| | STEPANOL ® EHS | 100 | | |
| Betaine | AMPHOSOL ® 810-B | 100 | 8 | 220 |
| | AMPHOSOL ® CG-50 | 100 | 7⅛ | 220 |
| | PETROSTEP ® LME-50 | 100 | 8 | 205 |
| | PETROSTEP ® B1235 | 100 | 8 | 205 |
| | AMPHOSOL ® 810-B/PETROSTEP ® B1235 | 20:80 | 8 | 210 |
| | AMPHOSOL ® 810-B/PETROSTEP ® B1235 | 50:50 | 7½ | 210 |
| | AMPHOSOL ® 810-B/PETROSTEP ® B1235 | 80:20 | 8½ | 220 |
| | PETROSTEP ® MME-50 | 100 | 6½ | 210 |
| Betaine/ | AMPHOSOL ® 810-B/STEPANOL ® EHS | 80:20 | 8½ | 206 |
| Commercial | PETROSTEP ® LME-50/STEPANOL ® EHS | 80:20 | 7½ | 210 |
| Blends | AMPHOSOL ® 810-B/CEDEPAL ® FA-403 | 80:20 | 9 | 205 |
| | AMPHOSOL ® 810-B/POLYSTEP ® B-25 | 10:90 | 7⅝ | 192 |
| | AMPHOSOL ® 810-B/POLYSTEP ® B-25 | 50:50 | 7¼ | 200 |
| | AMPHOSOL ® 810-B/POLYSTEP ® B-25 | 80:20 | 8½ | 200 |
| | AMPHOSOL ® 810-B/POLYSTEP ® B-25 | 90:10 | 7¾ | 180 |

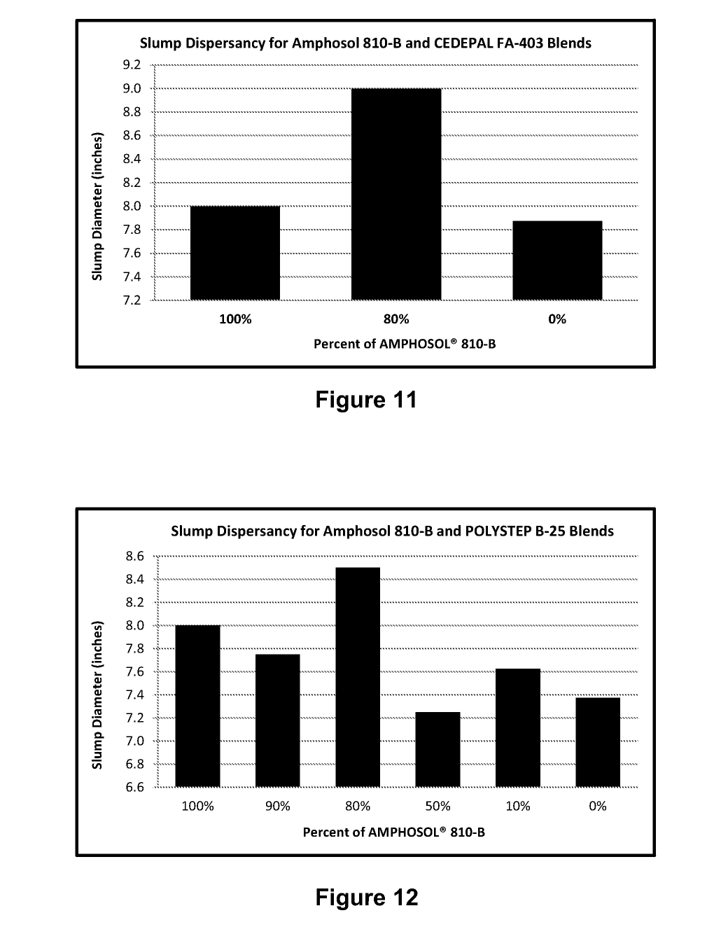

The results in Table 5 show that most of the test slurries containing the betaine foaming agents have better spread distance than the commercial foaming agents, indicating better fluidity of the slurry. Even more surprising, the combination of the betaine foaming agent with any of the commercial foaming agents synergistically resulted in a spread distance for the combination that was greater than that of any of the foaming agents alone. This is graphically illustrated in FIGS. 10-12. Increased fluidity is an important property because it may allow a decrease in the water added to the calcined gypsum slurry during wallboard manufacture, resulting in less drying time and consequent energy savings.

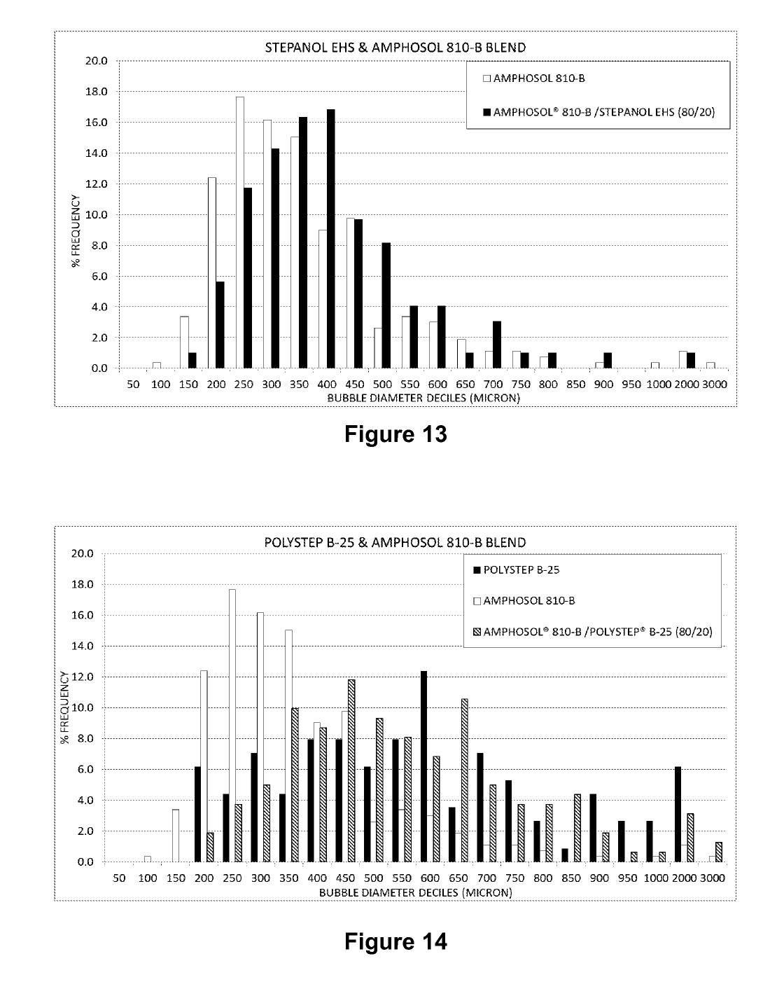

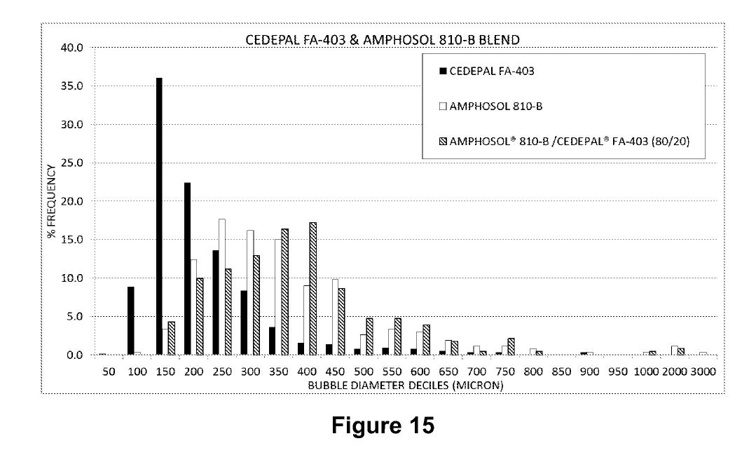

The bubble core structures of slumps prepared from the test slurries were analyzed for bubble size distribution. FIGS. 13-15 graphically illustrate bubble diameter percent frequency distributions for the analyzed slumps. From FIGS. 13-14 it can be seen that a slump made with a blend of betaine and an alkyl sulfate containing as little as 20% alkyl sulfate, produced a distribution of larger sized calcined gypsum slurry bubbles than what is observed for bubble sizes of slumps made with the individual betaine or alkyl sulfate components. From FIG. 15 it can be seen that a blend of betaine with an alkyl ether sulfate, containing as little as 20% alkyl ether sulfate, produces a bubble size distribution nearly identical to that of the alkyl ether sulfate alone.

The present technology is now described in such full, clear and concise terms as to enable a person skilled in the art to which it pertains to practice the same. It is to be understood that the foregoing describes preferred embodiments of the present technology, and that modifications may be made therein without departing from the spirit or scope of the present technology as set forth in the claims.

What is claimed is:

1. A gypsum composition comprising, in combination with calcined gypsum and water, a foaming agent composition comprising (a) at least one surfactant selected from alkyl sulfates and alkyl ether sulfates, and blends thereof, and (b) at least one betaine.

2. The gypsum composition of claim 1, wherein the at least one betaine has the following formula I or II: 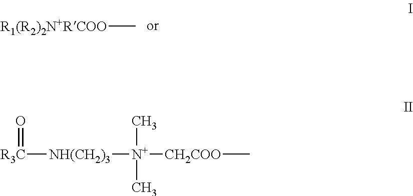
where R₁ is a C6 to C18 hydrocarbon, R₂ is a C1 to C3 alkyl, R′ is a C1 to C5 alkyl, hydroxyl alkyl, alkoxylated alkyl, or a combination thereof, and R₃ is C6 to C22 hydrocarbon.

3. The gypsum composition of claim 1 wherein the at least one betaine is a mixture of different betaines.

4. The gypsum composition of claim 1, wherein the foaming agent composition comprises from about 10% to about 90% by weight of the alkyl sulfate, alkyl ether sulfate, or blend thereof, and from about 90% to about 10% by weight of the at least one betaine.

5. The gypsum composition of claim 1, wherein the foaming agent composition comprises from about 0.01% to about 99.99% by weight of the alkyl sulfate, alkyl ether sulfate, or blend thereof, and from about 99.99% to about 0.01% by weight of the at least one betaine.

6. The gypsum composition of claim 1, wherein the at least one alkyl sulfate has the following formula:
R_{X}OSO₃⁻M⁺
where R represents a linear or branched chain hydrocarbon, x is between 6 and 16 and M+ is a cation capable of producing a water soluble surfactant.

7. The gypsum composition of claim 1, wherein the at least one alkyl ether sulfate has the following formula:
R_{X}(OCH₂CH₂)_{y}OSO₃⁻M⁺
where R represents a linear or branched chain hydrocarbon, x is between 6 and 16, y is between 0.01 and 12, and M⁺ is a cation capable of producing a water soluble surfactant.

8. The gypsum composition of claim 6, wherein the at least one alkyl sulfate is selected from sodium 2-ethyl-hexyl sulfate and sodium decyl sulfate.

9. The gypsum composition of claim 1, wherein the at least one betaine is selected from cocoamidopropyl betaine, capryl/capramidopropyl betaine, and lauramido propyl betaine.

10. The gypsum composition of claim 6, wherein M+ is selected from the group consisting of sodium, potassium, magnesium, ammonium, and mixtures thereof.

11. The gypsum composition of claim 7, wherein M+ is selected from the group consisting of sodium, potassium, magnesium, ammonium, and mixtures thereof.

12. A method of producing a foamed gypsum composition comprising:
mixing a foaming agent composition comprising (a) at least one surfactant selected from alkyl sulfates and alkyl ether sulfates, and blends thereof, and (b) at least one betaine, with water and air to generate a foam;
introducing the foam into a calcined gypsum slurry comprising calcined gypsum and water to produce a foamed calcined gypsum slurry.

13. The method of claim 12, wherein the at least one betaine has the following formula I or II: 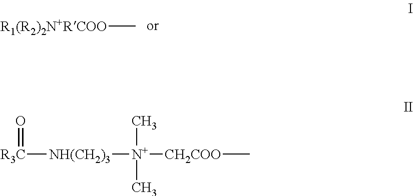
where R₁ is a C6 to C18 hydrocarbon, R₂ is a C1 to C3 alkyl, R′ is a C1 to C5 alkyl, hydroxyl alkyl, alkoxylated alkyl, or a combination thereof, and R₃ is C6 to C22 hydrocarbon.

14. The method of claim 12, wherein the at least one betaine comprises a mixture of different betaines.

15. The method of claim 12, wherein the foaming agent composition comprises from about 10% to about 90% by weight of the alkyl sulfate, alkyl ether sulfate, or blend thereof, and from about 90% to about 10% by weight of the at least one betaine.

16. The method of claim 12, wherein the foaming agent composition comprises from about 0.01% to about 99.99% by weight of the alkyl sulfate, alkyl ether sulfate, or blend thereof, and from about 99.99% to about 0.01% by weight of the at least one betaine.

17. The method of claim 12, wherein the at least one alkyl sulfate has the following formula:
R_{X}OSO₃⁻M⁺
where R represents a linear or branched chain hydrocarbon, x is between 6 and 16 and M+ is a cation capable of producing a water soluble surfactant.

18. The method of claim 12, wherein the at least one alkyl ether sulfate has the following formula:
R_{X}(OCH₂CH₂)_{y}OSO₃⁻M⁺
where R represents a linear or branched chain hydrocarbon, x is between 6 and 16, y is between 0.01 and 12, and M⁺ is a cation capable of producing a water soluble surfactant.

19. The method of claim 12, wherein the at least one alkyl sulfate is selected from sodium 2-ethyl-hexyl sulfate and sodium decyl sulfate.

20. The method of claim 12, wherein the at least one betaine is selected from cocoamidopropyl betaine, capryl/capramidopropyl betaine, and lauramido propyl betaine.

21. The method of claim 17, wherein M+ is selected from the group consisting of sodium, potassium, magnesium, ammonium, and mixtures thereof.

22. The method of claim 18, wherein M+ is selected from the group consisting of sodium, potassium, magnesium, ammonium, and mixtures thereof.

23. A gypsum board prepared from the gypsum composition of claim 1.

24. A gypsum board prepared by the method of claim 12.
